(19) United States
(12) Patent Application Publication
(10) Pub. No.: US 2010/0141101 A1
(43) Pub. Date: Jun. 10, 2010

(54) SENSOR INCLUDING AN ANTI-ROTATION MECHANISM

(75) Inventors: Brad Chamberlin, Pendleton, IN (US); Steve Burton, Anderson, IN (US); Balazs Palfai, Fishers, IN (US)

Correspondence Address: CANTOR COLBURN, LLP, 20 Church Street, 22nd Floor, Hartford, CT, 06103, US

(73) Assignee: REMY TECHNOLOGIES, L.L.C., Pendleton, IN (US)

(21) Appl. No.: 12/391,688

(22) Filed: Feb. 24, 2009

(51) Int. Cl. H02K 11/00

(52) U.S. Cl. 310/68 B

(57) ABSTRACT

A sensor assembly includes a main body having an outer wall member, an inner wall member, and an intermediate portion. The main body including a central opening defined by the inner wall member. The sensor assembly further includes at least one anti-rotation mechanism formed on the inner wall member. The at least one anti-rotation mechanism is adapted to deflect radially toward the outer wall member upon engagement with a component to be sensed. Upon deflection, the at least one anti-rotation mechanism fixedly secures the sensor assembly to the component to be sensed.

### BACKGROUND

Exemplary embodiments of the invention relate to the art of sensors and, more particularly, to a sensor including an anti-rotation mechanism.

Sensors mounted to rotating components in, for example, motors must be restrained from movement in order to minimize output anomalies or distortions. The sensor must be retained in place over the entire operational life of the motor. Conventional methods of mounting a sensor to a rotating shaft include staking, welding and using a press-fit. Staking a sensor to a shaft requires the application of an impact force. Applying an impact force to a sensor can damage internal components that lead to measurement inconsistencies. Welding a sensor in place, or welding a sensor retainer to hold the sensor also results in measurement abnormalities. Exposing sensors to heat can cause internal damage resulting in data distortion. Using an interference or press-fit creates a deformation in the sensor that can adversely affect internal sensor components. Damage to internal sensor components will lead to undesirable data inconsistencies.

### SUMMARY

In accordance with an exemplary embodiment, a sensor assembly includes a main body having an outer wall member, an inner wall member, and an intermediate portion. The main body including a central opening defined by the inner wall member. The sensor assembly further includes at least one anti-rotation mechanism formed on the inner wall member. The at least one anti-rotation mechanism member is adapted to deflect radially toward the outer wall member upon engagement with a component to be sensed. Upon deflection, the at least one anti-rotation mechanism fixedly secures the sensor assembly to the component to be sensed.

In accordance with another exemplary embodiment, a method of mounting a sensor to a component to be sensed includes positioning the sensor upon a first end portion of the component to be sensed, urging the sensor from the first end portion toward a second end portion of the component to be sensed, engaging a deflecting element provided on the component to be sensed and an anti-rotation mechanism formed on an inner wall of the sensor and, urging the anti-rotation mechanism radially outward of the component to be sensed. The anti-rotation mechanism gripping the component to be sensed to restrict movement of the sensor.

Additional features and advantages are realized through the techniques of the exemplary embodiments. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an elevational view of a sensor assembly including an anti-rotation mechanism in accordance with an exemplary embodiment;

FIG. 2 is a partial elevational view of the sensor assembly of FIG. 1 mounted to a component to be sensed;

FIG. 3 is an elevational view of a sensor assembly including an anti-rotation mechanism in accordance with another exemplary embodiment; and

FIG. 4 is a partial elevational view of a sensor assembly including an anti-rotation mechanism in accordance with yet another exemplary embodiment.

### DETAILED DESCRIPTION

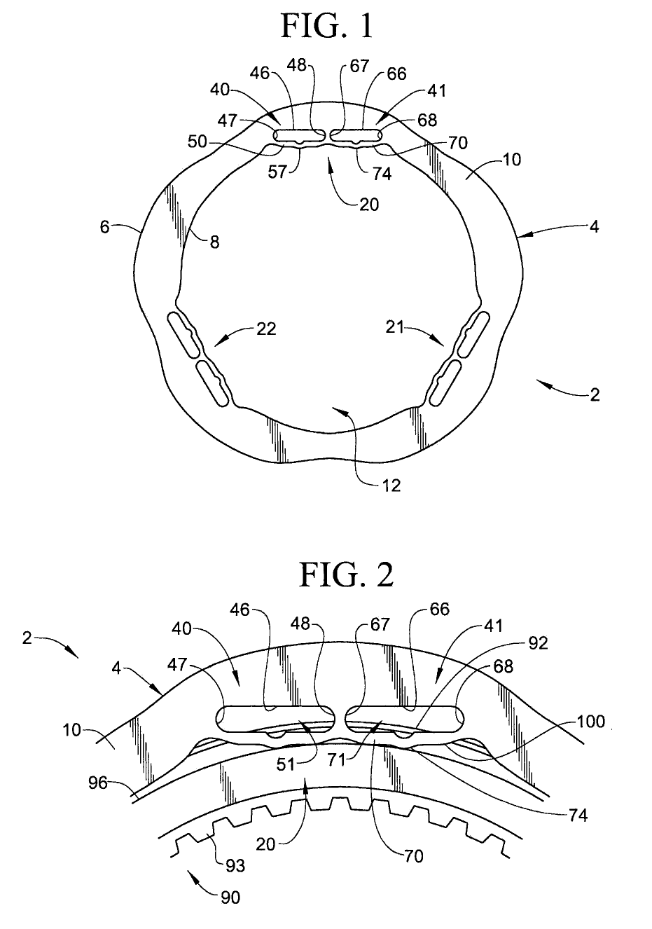

With reference to FIG. 1, a sensor assembly, constructed in accordance with exemplary embodiments, is generally indicated at 2. Sensor assembly 2 includes a main body 4 that houses a variety of electronic components (not shown) depending upon desired sensing. Main body 4 includes an outer wall member 6, an inner wall member 8 and a generally annular intermediate portion 10. Intermediate portion 10 joins outer wall member 6 and inner wall member 8. In the exemplary embodiment shown, main body 4 includes a central opening 12 defined by inner wall member 8. In accordance with the exemplary embodiments, sensor assembly 2 includes a plurality of anti-rotation mechanisms shown in the form of deflection members 20-22 arranged in inner wall member 8. Deflection members 20-22 are spaced evenly about inner wall member 8 in order to facilitate a proper balance of sensor assembly 2. At this point, it should be understood that as each deflection member 20-22 is similarly formed, a detailed description will follow with respect to deflection member 20 with an understanding that the remaining deflection members 21-22 are similarly formed.

As best seen in FIG. 2, deflection member 20 includes a first deflection element 40 and a second deflection element 41. First deflection element 40 includes an inner wall section 46, a first side wall section 47 and a second side wall section 48. First and second side wall sections 47 and 48 are joined by a substantially linear bridge section 50 so as to collectively define a generally circular opening or deflection zone 51. As will be discussed more fully below, first deflection element 40 includes a deflection portion 54 arranged centrally along bridge section 50. Similarly, second deflection element 41 includes an inner wall section 66, a first side wall section 67 and a second side wall section 68. First and second side wall sections 67 and 68 are joined by a substantially linear bridge section 70 so as to collectively define a generally circular opening or deflection zone 71. In a manner also similar to that described above, second deflection element 41 includes a deflection portion 74 arranged centrally along bridge section 70.

In accordance with the exemplary embodiment shown, sensor assembly 2 is configured to fixedly mount to a component to be sensed. Towards that end, sensor assembly 2 is fixedly mounted to a shaft 90 having a first or outer diametric portion 92 and an inner splined portion 93. Shaft 90 further includes a second or inner diametric portion having a diameter that is less than outer diametric portion 92. Second diametric portion 96 includes a deflector member 100 which, as will be discussed more fully below, is configured to engage with deflection portions 54 and 74. More specifically, sensor assembly 2 is configured to mount to shaft 90 such that when fully seated, deflector member 100 urges each deflection portion 54 and 74 into deflection zones 51 and 71 respectively. Deflector member 100 causes a non-elastic deformation in each bridge section 50, 70 in order to create an interference-type fit between sensor assembly 2 and shaft 90. More specifically, bridge sections deform or deflect radially between about 0.1 mm and about 0.3 mm. With this particular arrangement, sensor assembly 2 is fixedly secured to shaft 90 without the need for various joining processes such as staking, which would otherwise impart a sharp force to sensor assembly 2 and could damage internal electronic components, welding which requires heat which would also affect internal components and the like. That is, by elastically deforming bridge sections 50 and 70 into respective ones of deflection zones 51 and 71, deflection portions 54 and 74 fixedly engage deflector member 100 ensuring that sensor 2 does not rotate relative to shaft 90.

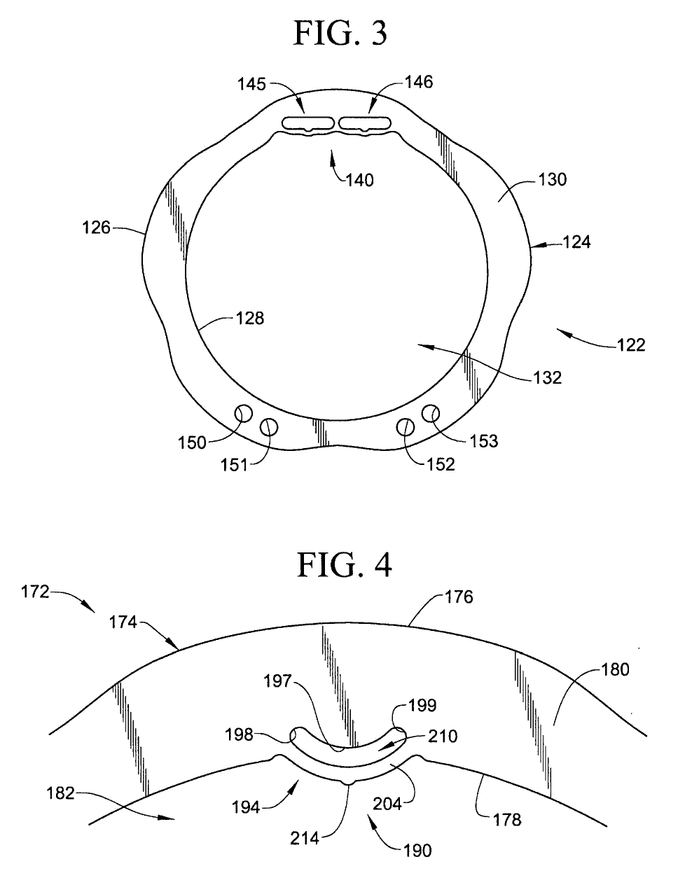

Reference will now be made to FIG. 3 in describing a sensor assembly 122 constructed in accordance with another exemplary embodiment. As shown, sensor assembly 122 includes a main body 124 having an outer wall member 126, an inner wall member 128, and a generally annular intermediate portion 130. Intermediate portion 130 joins outer wall member 126 and inner wall member 128. Main body 124 includes a central opening 132 defined by inner wall member 128. As shown, sensor assembly 122 includes a single anti-rotation mechanism shown in the form of a deflection member 140 having a first deflection element 145 and a second deflection element 146. First and second deflection elements 145 and 146 are formed in a manner similar to that described above with respect to deflection elements 40 and 41. In any event, given the existence of a single deflection member 140, sensor assembly 2 must be balanced in order to ensure proper operation. Towards that end, sensor assembly 2 includes a plurality of balancing elements shown in the form of openings 150-153 formed in substantially annular intermediate portion 130. Balancing elements 150-153 ensure that sensor assembly 2 does not contribute to an out-of-balance condition for shaft 90.

Reference will now be made to FIG. 4 in describing a sensor assembly 172 constructed in accordance with yet another exemplary embodiment. As shown, sensor assembly 172 includes a main body 174 having an outer wall member 176, an inner wall member 178, and a generally annular intermediate portion 180. Intermediate portion 180 joins outer wall member 176 and inner wall member 178. Main body 174 includes a central opening defined by inner wall member 178. In the embodiment shown, sensor assembly 172 includes an anti-rotation mechanism shown in the form of a deflection member 190 having a single deflection element 194. As shown, deflection element 194 includes an inner wall section 197, a first side wall section 198 and a second side wall section 199. First and second side wall sections 198 and 199 are joined by a generally arcuate bridge section 204. With this arrangement, innerwall section 197, first and second side wall sections 198, 199 and arcuate bridge section 204 collectively define a generally arcuate opening or deflection zone 210. In a manner similar to that described above, bridge section 204 includes a deflection portion 214 that is configured to engage with a deflector member (not shown) in order to establish an inelastic deformation within bridge section 204.

At this point, it should be understood that the present invention provides a system for joining a sensor assembly to a rotating shaft without requiring any external forces or heat be generated to sensor assembly 2 during installation. In addition, it should be understood that while shown and described with respect to a sensor for detecting rotation, the sensor assembly described herein can be used in a variety of applications that require minimal contact or disturbance of the sensor during installation. In addition, it should be understood that the amount of deflection of the deflection element can vary depending upon the geometry of the sensor. Finally, it should be understood that the particular shape of the deflection element can vary and include structure that is supported at the deflection zone at two ends or structure that is cantilevered from a single end.

In general, this written description uses examples to disclose exemplary embodiments, including the best mode, and also to enable any person skilled in the art to practice the exemplary embodiments, including making and using any devices or systems and performing any incorporated methods. The patentable scope of the exemplary embodiment is defined by the claims, and may include other examples that occur to those skilled in the art. Such other examples are intended to be within the scope of exemplary embodiments if they have structural elements that do not differ from the literal language of the claims, or if they include equivalent structural elements with insubstantial differences from the literal language of the claims.

1. A sensor assembly comprising:
a main body having an outer wall member, an inner wall member and an intermediate portion, the main body including a central opening defined by the inner wall member; and
at least one anti-rotation mechanism formed on the inner wall member, the at least one anti-rotation mechanism being adapted to deflect radially toward the outer wall member upon engagement with a component to be sensed, wherein upon deflection, the at least one anti-rotation mechanism fixedly secures the sensor assembly to the component to be sensed.

2. The sensor assembly according to claim 1, wherein the at least one anti-rotation mechanism comprises a deflection member including at least one deflection element.

3. The sensor assembly according to claim 2, wherein the at least one deflection element includes an inner wall section having first and second side wall sections and a bridge section that collectively define a deflection zone.

4. The sensor assembly according to claim 3, wherein the deflection zone comprises a generally circular opening.

5. The sensor assembly according to claim 3, wherein the deflection zone comprises a generally arcuate opening.

6. The sensor assembly according to claim 3, wherein the bridge section includes at least one deflection portion, the at least one deflection portion being adapted to engage the component to be sensed and urge the bridge member into the deflection zone.

7. The sensor assembly according to claim 1, wherein the at least one anti-rotation mechanism includes a first anti-rotation mechanism, a second anti-rotation mechanism, and a third anti-rotation mechanism.

8. The sensor assembly according to claim 7, wherein the first, second and third anti-rotation mechanisms are spaced about the inner wall member of the main body.

9. The sensor assembly according to claim 7, wherein each of the first, second and third anti-rotation mechanisms includes first and second deflection elements.

10. The sensor assembly according to claim 1, further comprising: at least one balancing element formed in the main body.

11. The sensor assembly according to claim 10, wherein the at least one balancing element comprises an opening formed in the main body.

12. The sensor assembly according to claim 10, wherein the at least one balancing element is formed directly opposite the at least one anti-rotation mechanism.

13. The sensor assembly according to claim 1, wherein the sensor assembly is a motor sensor mounted to a rotating shaft, the at least one anti-rotation mechanism gripping the rotating shaft to prevent movement of the sensor assembly.

14. A method of mounting a sensor to a component to be sensed, the method comprising:
positioning the sensor upon a first end portion of the component to be sensed;
urging the sensor from the first end portion toward a second end portion of the component to be sensed;
engaging a deflecting element provided on the component to be sensed and an anti-rotation mechanism formed on an inner wall of the sensor;
urging the anti-rotation mechanism radially outward of the component to be sensed, the anti-rotation mechanism gripping the component to be sensed to restrict movement of the sensor.

15. The method of claim 14, wherein engaging the deflecting element and the anti-rotation mechanism comprises forcing the deflecting element into the anti-rotation mechanism to create a partial interference fit.

16. The method of claim 15, wherein forcing the deflecting element into the anti-rotation mechanism comprises deflecting a bridge member into a deflection zone.

17. The method of claim 16, wherein deflecting the bridge member into the deflection zone comprised deflecting the bridge member between about 0.1 mm and about 0.3 mm.

18. The method of claim 14, wherein engaging the deflecting element and the anti-rotation mechanism comprises engaging multiple deflecting elements formed on the components to be sensed and multiple anti-rotation mechanism arranged about the inner wall of the sensor.

19. The method of claim 14, urging the anti-rotation mechanism radially outward of the component to be sensed comprises forcing the anti-rotation mechanism into an opening formed in the inner wall of the sensor.

20. The method of claim 14, further comprising: sensing a rotational force applied to the component to be sensed.
